(19) United States
(12) Patent Application Publication
(10) Pub. No.: US 2011/0160112 A1
(43) Pub. Date: Jun. 30, 2011

(54) CLEANING COMPOSITION

(75) Inventors: Song-Yuan Chang, Chiayi County (TW); Po-Yuan Shen, Taoyuan County (TW); Wen-Tsai Tsai, Taipei City (TW); Ming-Hui Lu, Taipei City (TW); Cheng-Hsun Chan, Tainan County (TW)

(73) Assignee: UWiZ Technology Co., Ltd., Taoyuan County (TW)

(21) Appl. No.: 12/897,789

(22) Filed: Oct. 5, 2010

(30) Foreign Application Priority Data
Dec. 25, 2009 (TW) 98145072

(51) Int. Cl. C11D 3/26

(52) U.S. Cl. 510/175

(57) ABSTRACT

A cleaning composition including a polyamino carboxylic salt, an acid and water is provided. The content of the polyamino carboxylic salt is 0.01 wt % to 0.5 wt %. The content of the acid is 0.01 wt % to 0.5 wt %. The remaining portion of the cleaning composition is water.

### CROSS-REFERENCE TO RELATED APPLICATION

This application claims the priority benefit of Taiwan application serial no. 98145072, filed on Dec. 25, 2009. The entirety of the above-mentioned patent application is hereby incorporated by reference herein and made a part of specification.

### BACKGROUND OF THE INVENTION

1. Field of the Invention

The invention relates to a composition adopted in a semiconductor fabrication and more particularly to a cleaning composition adopted after a chemical mechanical polishing process.

2. Description of Related Art

In the fabrication of a very-large-scale integrative (VLSI) circuit, the chemical mechanical polishing (CMP) process provides a global planarization of a wafer surface. The CMP process is indeed an essential fabrication technology as the semiconductor fabrication is performed at a sub-micron scale.

Among all of the items for evaluating the performance of the CMP process, the existence of defects is one of the important items. The defects generated in the CMP process include organic residues, small particles, micro-scratches, and corrosions. Here, organic residues are resulted from the interaction of the chemical composition of the polishing slurry. Components of the polishing slurry sometimes cross-interact with the metal layer so as to leave contaminants such as residues or blots on the surface of the polishing pad or the tool. If the contaminants are not washed off, the performance of the polishing pad is lowered to decrease the film removal rate. Consequently, the uniformity of the film removal rate is affected and the lifespan of the polishing pad is further shortened.

For instance, after the step of polishing the copper metal or the barrier layer, benzotriazole residues are usually left on the wafer and the polishing pad. These residues are hard to remove and affect the electric performance of the devices and shorten the lifespan of the polishing pad.

Thus, in order to remove the contaminants produced after the CMP process, an additional cleaning step has to be carried out after the CMP process. Currently, integrative circuit manufactures remove the contaminants on the surface of the wafer by scrubbing, spray rinsing, or sonic cleaning with acidic or neutral cleaning solutions. Nevertheless, acidic or neutral cleaning solutions remove the metal conductive lines on the wafer excessively so as to increase the roughness on the surface of the wafer. Moreover, the cleaning solutions reduce the recyclability of the polishing pad.

The conventional cleaning methods fail to remove the contaminants effectively and improve the surface property of the wafer after the CMP process. As a result, the industry is searching for a cleaning method which can effectively remove the residual contaminants on the wafer surface after the CMP process, maintain the planarity of the wafer surface, and be an economically efficient cleaning method after the CMP process.

### SUMMARY OF THE INVENTION

The invention is directed to a cleaning composition capable of effectively removing residues generated after a chemical mechanical polishing (CMP) process.

The invention is directed to a cleaning composition including a polyamino carboxylic salt, an acid, and water. A content of the polyamino carboxylic salt is 0.01 weight percentage (wt %) to 0.5 wt %. A content of the acid is 0.01 wt % to 0.5 wt %. Here, a remaining portion of the cleaning composition is water.

According to one embodiment of the invention, in the cleaning composition aforementioned, the polyamino carboxylic salt is selected from at least one of a basic metal salt and an ammonium salt of ethylenediaminetetraacetic acid, diethylenetriaminepentatacetic acid, nitrilotriacetic acid, N-(hydroxyethyl)-ethylenediaminetriacetic acid, and hydroxyethyliminodiacetic acid.

According to one embodiment of the invention, in the cleaning composition, the acid is at least one of phosphonic carboxylic acid and carboxylic acid.

According to one embodiment of the invention, in the cleaning composition, phosphonic carboxylic acid is selected from at least one of 2-aminoethylphosphonic acid (AEPN), dimethyl methylphosphonate (DMMP), 1-hydroxy ethylidene-1,1-diphosphonic acid (HEDP), amino tris(methylene phosphonic acid) (ATMP), ethylenediamine tetra(methylene phosphonic acid) (EDTMP), tetramethylenediamine tetra(methylene phosphonic acid) (TDTMP), hexamethylenediamine tetra(methylene phosphonic acid) (HDTMP), diethylenetriamine penta(methylene phosphonic acid) (DTPMP), 2-phosphonobutane-1,2,4-tricarboxlic acid (PBTC), N-(phosphonomethyl)iminodiacetic acid) (PMIDA), 2-carboxyethyl phosphonic acid (CEPA) and 2-hydroxyphosphonocarboxylic acid (HPAA).

According to one embodiment of the invention, in the cleaning composition, carboxylic acid is selected from at least one of formic acid, acetic acid, propionic acid, oxalic acid, acrylic acid, benzoic acid, maleic acid, malic acid, glutaric acid, malonic acid, adipic acid, citric acid, and aconitic acid.

According to one embodiment of the invention, in the cleaning composition, the cleaning composition further includes a surfactant.

According to one embodiment of the invention, in the cleaning composition, the surfactant is a nonionic surfactant, an anionic surfactant, or a combination thereof.

According to one embodiment of the invention, in the cleaning composition, the nonionic surfactant is selected from at least one of alkyl poly(ethylene oxide), alkylphenol poly(ethylene oxide), and alkyl polyglucoside.

According to one embodiment of the invention, in the cleaning composition, the anionic surfactant is selected from at least one of alkyl sulfate salt and alkyl benzene sulfonate.

According to one embodiment of the invention, in the cleaning composition, alkyl sulfate salt is selected from at least one of sodium dodecyl sulfate, ammonium lauryl sulfate, and sodium laureth sulfate.

According to one embodiment of the invention, in the cleaning composition, alkyl benzene sulfonate includes dodecylbenzene sulfonic acid.

According to one embodiment of the invention, in the cleaning composition, the cleaning composition includes an ion enhancer having a content of 0.01 wt % to 0.5 wt %.

According to one embodiment of the invention, in the cleaning composition, the ion enhancer is selected from at least one of an amine salt, a potassium salt, a sodium salt, and a lithium salt of formic acid, acetic acid, propionic acid, oxalic acid, acrylic acid, benzoic acid, maleic acid, malic acid, glutaric acid, malonic acid, adipic acid, citric acid, aconitic acid, salicylic acid, tartaric acid, glycolic acid, and sulfonic acid.

According to one embodiment of the invention, in the cleaning composition, the cleaning composition is condensed into a highly concentrated cleaning composition.

According to one embodiment of the invention, in the cleaning composition, the highly concentrated cleaning composition has a concentration multiple of 20 times to 60 times.

According to one embodiment of the invention, in the cleaning composition, a pH value of the cleaning composition ranges from 8 to 12.

In light of the foregoing, as the cleaning composition provided in the invention includes polyamino carboxylic salt, the cleaning composition is thus basic and capable of cleaning, without damaging, the wafer and the polishing pad after the CMP process.

Since the polishing slurry used in the CMP process and the cleaning composition provided in the invention are both basic, pH shock is thus prevented. On the other hand, in the basic environment, the abrasive grains have higher zeta potential so as to enhance the cleaning capability of the cleaning composition.

In order to make the aforementioned and other features and advantages of the invention more comprehensible, several embodiments accompanied with figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIGS. 1A and 1B are photographs taken after cleaning a wafer with deionized water after a chemical mechanical polishing (CMP) process according to one experimental embodiment of the invention.

FIGS. 2A and 2B are photographs taken after cleaning a wafer with a POU sample of formula 7 after the CMP process according to one experimental embodiment of the invention.

### DESCRIPTION OF EMBODIMENTS

Firstly, a cleaning composition of the invention is illustrated. The cleaning composition is suitable for cleaning a wafer and a polishing pad after a chemical mechanical polishing (CMP) process.

A cleaning composition of one embodiment of the invention includes a polyamino carboxylic salt, an acid, and water.

A content of the polyamino carboxylic salt is 0.01 weight percentage (wt %) to 0.5 wt %, so that the cleaning composition could be basic. A pH value of the cleaning composition ranges, for example, from 8 to 12. The polyamino carboxylic salt is selected from at least one of a basic metal salt and an ammonium salt of ethylenediaminetetraacetic acid, diethylenetriaminepentatacetic acid, nitrilotriacetic acid, N-(hydroxyethyl)-ethylenediaminetriacetic acid, and hydroxyethyliminodiacetic acid, for example.

A content of the acid is 0.01 wt % to 0.5 wt %. The acid is at least one of phosphonic carboxylic acid and carboxylic acid, for example.

Carboxylic acid is selected from at least one of formic acid, acetic acid, propionic acid, oxalic acid, acrylic acid, benzoic acid, maleic acid, malic acid, glutaric acid, malonic acid, adipic acid, citric acid, and aconitic acid, for example.

Phosphonic carboxylic acid is, for example, selected from at least one of 2-aminoethylphosphonic acid (AEPN), dimethyl methylphosphonate (DMMP), 1-hydroxy ethylidene-1,1-diphosphonic acid (HEDP), amino tris(methylene phosphonic acid) (ATMP), ethylenediamine tetra(methylene phosphonic acid) (EDTMP), tetramethylenediamine tetra(methylene phosphonic acid) (TDTMP), hexamethylenediamine tetra(methylene phosphonic acid) (HDTMP), diethylenetriamine penta(methylene phosphonic acid) (DTPMP), 2-phosphonobutane-1,2,4-tricarboxlic acid (PBTC), N-(phosphonomethyl)iminodiacetic acid) (PMIDA), 2-carboxyethyl phosphonic acid (CEPA) and 2-hydroxyphosphonocarboxylic acid (HPAA).

In addition, the cleaning composition could further include a surfactant to increase the hydrophilicity of the cleaning composition. The surfactant is a nonionic surfactant, an anionic surfactant, or a combination thereof, for instance. The nonionic surfactant is selected from, for instance, at least one of alkyl poly(ethylene oxide), alkylphenol poly(ethylene oxide), and alkyl polyglucoside. The anionic surfactant is selected from, for instance, at least one of alkyl sulfate salt and alkyl benzene sulfonate. Alkyl sulfate salt is selected from at least one of sodium dodecyl sulfate, ammonium lauryl sulfate, and sodium laureth sulfate, for example. Alkyl benzene sulfonate includes dodecylbenzene sulfonic acid, for example.

The cleaning composition could further include an ion enhancer having a content of 0.01 wt % to 0.5 wt %, such that the etching capacity of the cleaning composition could be enhanced. The ion enhancer is, for example, selected from at least one of an amine salt, a potassium salt, a sodium salt, and a lithium salt of formic acid, acetic acid, propionic acid, oxalic acid, acrylic acid, benzoic acid, maleic acid, malic acid, glutaric acid, malonic acid, adipic acid, citric acid, aconitic acid, salicylic acid, tartaric acid, glycolic acid, and sulfonic acid.

A remaining portion of the cleaning composition is water. Here, water is deionized water, for example.

It should be noted that based on commercial consideration, the cleaning composition could be condensed into a highly concentrated cleaning composition, such that the weight and volume of the cleaning composition could be reduced to greatly decrease the transportation cost and the storing space of the cleaning composition. The highly concentrated cleaning composition has a concentration multiple of 20 times to 60 times, for example.

Accordingly, as the cleaning composition provided in the present embodiment includes polyamino carboxylic salt, the cleaning composition is thus basic and capable of cleaning, without damaging, the wafer and the polishing pad after the CMP process.

Since the polishing slurry used in the CMP process and the cleaning composition provided in the present embodiment are both basic, pH shock is thus prevented. On the other hand, in the basic environment, the abrasive grains have higher zeta potential so as to prevent the abrasive grains from aggregating. Moreover, the cleaning ability of the small particles is enhanced and the solubility of organic residues such as benzotriazole is higher.

In the following, actual experimental tests are performed. Herein, formula 1 to formula 10 are concentrated products. In each of the experimental embodiments, the cleaning solution sample used for cleaning is a diluted sample, which is referred as a point-of-use (POU) sample.

### Experimental Embodiment 1

The compositions, ratios, and pH values of cleaning compositions of formulae 1 to 6 are illustrated in Table 1. Here, remaining portions of the cleaning compositions of formulae 1 to 6 are water. In experimental embodiment 1, the POU samples of formulae 1 to 6 are samples being diluted 40 times with deionized water.

TABLE 1

| | Composition | | | |
|---|---|---|---|---|
| | | Acid | | |
| | Polyamino | carboxylic | phosphonic | |
| | carboxylic salt | acid | carboxylic acid | |
| | KDTPA | citric acid | PBTC | pH value |
| Formula 1 | 8% | 3.47% | | 8.41 |
| Formula 2 | 8% | 2.15% | | 9.43 |
| Formula 3 | 8% | 1.28% | | 10.46 |
| Formula 4 | 8% | | 3.63% | 8.48 |
| Formula 5 | 8% | | 2.49% | 9.5 |
| Formula 6 | 8% | | 1.65% | 10.5 |

Note:
KDPTA: potassium diethylenetriaminepentaacetate
PBTC: 2-phosphonobutane-1,2,4-tricarboxlic acid

(1) Static Etching Rate Test

1. The wafer, measurement instrument, and experimental method, are illustrated in the following:

Wafer: a 200 millimeter (mm) copper covered wafer, where the thickness of the copper is 2000 Å

Measurement instrument: X-ray fluorescence spectrometer (XRF)

Experimental method: The cleaning compositions of formulae 1 to 6 are diluted 40 times with deionized water. The copper covered wafer is soaked in the diluted cleaning composition of formulae 1 to 6 for 240 minutes (min). The XRF is utilized to measure the thickness of the copper before and after the etching so as to calculate a static etching rate (SER).

2. The result of the SER test is shown in Table 2.

TABLE 2

| Sample | SER (Å/min) |
|---|---|
| POU sample of formula 1 | 4.6 |
| POU sample of formula 2 | 3.5 |
| POU sample of formula 3 | 3.45 |
| POU sample of formula 4 | 3.5 |
| POU sample of formula 5 | 2.5 |
| POU sample of formula 6 | 3.45 |

Referring to Table 2, the POU samples of formulae 1 to 6 have low SERs to the copper metal on the wafer, where the SERs are all lower than 5 Å/min. Accordingly, the POU samples of formulae 1 to 6 do not etch the copper metal excessively and do not result in under cut. Thus, the POU samples of formulae 1 to 6 are suitable for the conventional semiconductor fabrications.

(2) Wetting Test

1. The wafer, measurement instrument, and experimental method are illustrated in the following:

Wafer: 200 mm copper covered wafer and MIT 854 patterned wafer

Polishing slurry: SuperNova SN2000 copper polishing slurry and SuperNova 4500 barrier layer slurry

Measurement instrument: contact angle meter

Experimental method: The cleaning compositions of formulae 1 to 6 are diluted 40 times with deionized water. The contact angle meter is used to measure the contact angles of the POU samples of formulae 1 to 6 to the copper covered wafer.

As for the MIT 854 patterned wafer, the Applied Materials Mirra polishing apparatus is used to polish the MIT 854 patterned wafer with SuperNova SN2000 copper polishing slurry and SuperNova 4500 barrier layer slurry. The MIT 854 patterned wafer is cleaned using the POU samples of formulae 1 to 6 with a flow rate of 15 milliliter/minute (ml/min). After the MIT 854 patterned wafer is cleaned, the contact angle meter is used to measure the contact angle of deionized water to the MIT 854 patterned wafer.

2. The result of the wetting test is shown in Table 3.

TABLE 3

| | | Contact angle of |
|---|---|---|
| | Contact angle of | deionized water to wafer |
| | POU sample to | after cleaning with |
| Sample | wafer (°) | cleaning solution (°) |
| POU sample of formula 1 | 10 | 13.8 |
| POU sample of formula 2 | 21 | 10.2 |
| POU sample of formula 3 | 24.5 | 7.9 |
| POU sample of formula 4 | 14 | less than 7 |
| POU sample of formula 5 | 21 | less than 7 |
| POU sample of formula 6 | 16 | less than 7 |

Referring to Table 3, the POU samples of formulae 1 to 6 have small contact angles to the wafer, and thus have superior wetting ability. Moreover, deionized water also has small contact angles to the wafer being cleaned with the POU samples of formulae 1 to 6. Consequently, deionized water has superior wetting ability to the wafer being cleaned with the POU samples of formulae 1 to 6.

Accordingly, when the wafer is cleaned with the POU samples of formulae 1 to 6, the POU samples of formulae 1 to 6 and deionized water all have superior wetting ability to the wafer and can therefore clean the wafer.

(3) Roughness Test after Cleaning

1. The wafer, measurement instrument, and experimental method are illustrated in the following:

Wafer: MIT 854 patterned wafer

Polishing slurry: SuperNova SN2000 copper polishing slurry and SuperNova 4500 barrier layer slurry

Measurement instrument: Atomic force microscope (AFM)

Experimental method: the Applied Materials Mina polishing apparatus is used to polish the MIT 854 patterned wafer with SuperNova SN2000 copper polishing slurry and SuperNova 4500 barrier layer slurry. The MIT 854 patterned wafer is cleaned using the POU samples of formulae 1 to 6 with a flow rate of 15 ml/min. After the MIT 854 patterned wafer is cleaned, the AFM is utilized to measure the roughness on the wafer surface before and after etching.

2. The result of the roughness test is shown in Table 4.

TABLE 4

| | | Roughness | Root-mean-square |
|---|---|---|---|
| Sample | pH value | (Ra) (Å) | roughness) (Rm) |
| POU sample of formula 1 | 8.41 | 3.35 | 8.36 |
| POU sample of formula 2 | 9.43 | 2.52 | 5.19 |
| POU sample of formula 3 | 10.46 | 3.14 | 7.61 |
| POU sample of formula 4 | 8.48 | 3.18 | 4.46 |
| POU sample of formula 5 | 9.5 | 2.89 | 4.17 |
| POU sample of formula 6 | 10.5 | 3.28 | 4.34 |

Referring to Table 4, the POU samples of formulae 1 to 6 all have low degree of roughness to the copper metal on the wafer, where the values of Ra are all lower than 7 Å that is demanded by the specification. Accordingly, the wafer can obtain a better surface roughness by cleaning with the POU samples of formulae 1 to 6.

### Experimental Embodiment 2

The compositions, ratios, and pH values of cleaning compositions of formulae 7 to 10 are illustrated in Table 5. Here, remaining portions of the cleaning compositions of formulae 7 to 10 are water. Formulae 7 to 10 are concentrated products. In experimental embodiment 2, the POU samples of formulae 7 to 10 are samples being diluted 40 times with deionized water.

TABLE 5

| | Composition | | | | | |
|---|---|---|---|---|---|---|
| | Polyamino | Acid | Ion enhancer | | Surfactant | |
| | carboxylic salt | oxalic | ammonium | ammonium | dodecylbenzene | pH |
| Sample | KDTPA | acid | oxalate | citrate | sulfonic acid | value |
| Formula 7 | 2% | 1.15% | — | — | — | 8.41 |
| Formula 8 | 2% | 0.78% | — | — | 0.2% | 9.43 |
| Formula 9 | 2% | 0.65% | 1% | — | — | 10.46 |
| Formula 10 | 2% | 1.15% | — | 1% | — | 8.48 |

The SER test, the roughness test, the wetting test, the BTA solubility test, and the zeta potential test are performed to the POU samples of formulae 7 to 10, and the result is shown in Table 6.

TABLE 6

| | | | | | Zeta |
|---|---|---|---|---|---|
| | | | | | potential |
| | | | | BTA | 4% SiO₂ |
| | SER | Roughness | Contact | Solubility | abrasive |
| Sample | (Å/min) | (Å) | angle (°) | (%) | grains |
| Deionized | — | 3.52 | 82 | 1 | −25 |
| water | | | | | |
| POU sample | 1.57 | 3.55 | 30 | 2 | −57.6 |
| of formula 7 | | | | | |
| POU sample | 1.59 | 3.46 | 10 | 2 | −58.5 |
| of formula 8 | | | | | |
| POU sample | 1.89 | 4.39 | 22.16 | 2.15 | −55.4 |
| of formula 9 | | | | | |
| POU sample | 2.04 | 3.82 | 22.38 | 2.15 | −53.1 |
| of formula 10 | | | | | |

1. The Result of the SER Test:

Referring to Table 6, the POU samples of formulae 7 to 10 have low SERs to the copper metal on the wafer, where the SERs are all lower than 3 Å/min. Accordingly, the POU samples of formulae 7 to 10 do not etch the copper metal excessively.

2. The Result of the Roughness Test:

Referring to Table 6, the POU samples of formulae 7 to 10 all have low degree of roughness to the copper metal on the wafer, where the values of Ra are all lower than 7 Å which demanded by the specification.

3. The Result of the Wetting Test:

Referring to Table 6, as shown in the experimental result of the POU samples of formulae 7 and 8, since the anionic surfactant is added to formula 8, formula 8 has superior wetting ability comparing to that of formula 7.

4. BTA Solubility Test:

Referring to Table 6, the POU samples of formulae 7 to 10 have superior BTA solubility comparing to that of deionized water. Additionally, formula 9 added with ammonium oxalate and formula 10 added with ammonium citrate have superior BTA solubility. Accordingly, by adding ion enhancers such as ammonium oxalate and ammonium citrate in the cleaning composition, the solvation of organic residues such as BTA is enhanced while the SER, the roughness, and the wetting ability are maintained at a high level.

5. The Zeta Potential Test:

Referring to Table 6, the SiO₂ abrasive grains cleaned with the POU samples of formulae 7 to 10 have relatively high negative zeta potentials, such that the abrasive grains and the wafer have a large repulsion force therebetween. The abrasive grains are thus prevented from adhering to the wafer and consequently have superior cleaning ability.

### Experimental Embodiment 3

Experimental method: Two MIT 854 patterned wafers are provided. The

Applied Materials Mirra polishing apparatus is used to polish the MIT 854 patterned wafers with SuperNova SN2000 copper polishing slurry and SuperNova 4500 barrier layer slurry. The wafers are respectively cleaned with deionized water and the POU sample of formula 7. In experimental embodiment 3, the POU sample of formula 7 is a sample being diluted 40 times with deionized water.

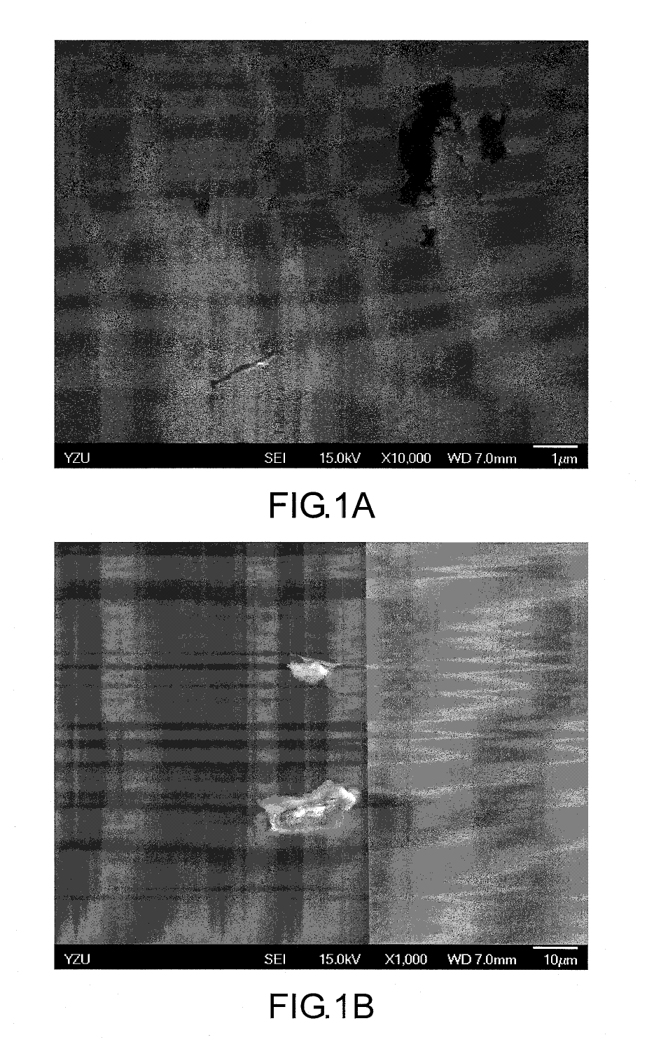

FIGS. 1A and 1B are photographs taken after cleaning a wafer with deionized water after the CMP process according to one experimental embodiment of the invention.

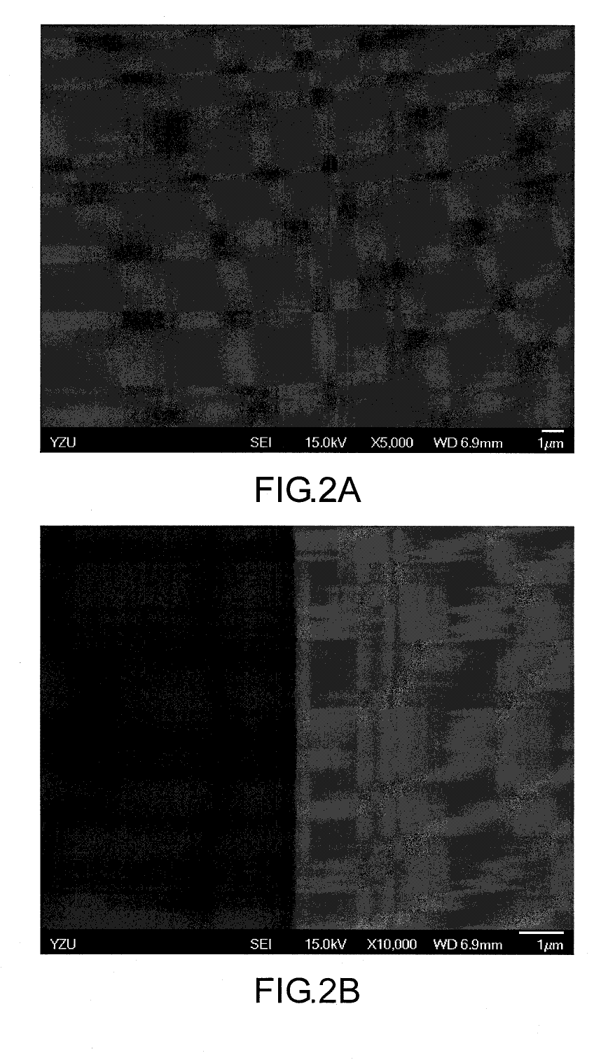

FIGS. 2A and 2B are photographs taken after cleaning a wafer with a POU sample of formula 7 after the CMP process according to one experimental embodiment of the invention.

Referring to FIGS. 1A and 1B simultaneously, a copper metal line region in FIG. 1A and a boundary between a copper metal line and a silicon oxide dielectric layer in FIG. 1B all showed organic residues on the wafer cleaned with deionized water. Accordingly, organic residues on the wafer cannot be effectively removed by cleaning with deionized water.

Referring to FIGS. 2A and 2B simultaneously, a copper metal line region in FIG. 2A and a boundary between a copper metal line and a silicon oxide dielectric layer in FIG. 2B did not have organic residues on the wafer cleaned with the POU sample of formula 7. Accordingly, organic residues can be effectively removed by cleaning with the POU sample of formula 7.

### Experimental Embodiment 4

Metal Ion Residual Test:

1. Experimental method: Three MIT 854 patterned wafers are provided. The Applied Materials Mirra polishing apparatus is used to polish the MIT 854 patterned wafers with SuperNova SN2000 copper polishing slurry and SuperNova 4500 barrier layer slurry. One of the wafers is not cleaned with the cleaning solution, and the remaining two wafers are cleaned with the POU samples of formulae 5 and 7 respectively. The metal residues are measured with total reflection X-ray fluorescence (TXRF) spectroscopy. In experimental embodiment 4, the POU samples of formulae 5 and 7 are samples being diluted 40 times with deionized water.

2. The result of the metal ion residual test is shown in Table 7.

TABLE 7

| | Not using | | |
|---|---|---|---|
| | cleaning | POU sample | POU sample |
| Metal | solution | of formula 5 | of formula 7 |
| ion | (×10¹⁰ atom/cm²) | (×10¹⁰ atom/cm²) | (×10¹⁰ atom/cm²) |
| K | 469.60 | 3.07 | 0.89 |
| Ca | 1672.61 | 0.24 | 0.35 |
| Sc | 0.00 | 0.00 | 0.00 |
| Ti | 69.75 | 0.05 | 0.03 |
| Cr | 17.96 | 0.14 | 0.01 |
| Mn | 3.50 | 0.00 | 0.04 |
| Fe | 174.68 | 0.97 | 0.90 |
| Co | 0.87 | 0.00 | 0.00 |
| Ni | 30.55 | 0.41 | 0.22 |
| Cu | 86.28 | 0.00 | 0.00 |
| Zn | 327.88 | 0.06 | 0.00 |
| Zr | 0.00 | 0.00 | 0.00 |
| Nb | 94.28 | 0.00 | 0.00 |
| Tc | 105.21 | 0.00 | 0.00 |
| Pd | 42.83 | 0.00 | 0.00 |
| Ag | 0.00 | 0.00 | 0.00 |
| Cd | 0.00 | 0.00 | 0.00 |
| In | 0.00 | 0.00 | 0.32 |
| Sn | 12.29 | 0.00 | 0.00 |
| Sb | 0.00 | 0.00 | 0.00 |
| Te | 49.53 | 0.00 | 0.00 |

Referring to Table 7, a large amount of metal ion residues is found on the wafer not cleaned with the cleaning solution. However, only a small amount of metal ion residues is left on the wafers cleaned with the POU samples of formulae 5 and 7. Accordingly, metal ion residues on the wafer can be effectively removed by cleaning with the POU samples of formulae 5 and 7.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A cleaning composition, comprising:
a polyamino carboxylic salt, having a content of 0.01 weight percentage (wt %) to 0.5 wt %;
an acid, having a content of 0.01 wt % to 0.5 wt %; and
water, wherein a remaining portion of the cleaning composition is water.

2. The cleaning composition as claimed in claim 1, wherein the polyamino carboxylic salt is selected from at least one of a basic metal salt and an ammonium salt of ethylenediaminetetraacetic acid, diethylenetriaminepentatacetic acid, nitrilotriacetic acid, N-(hydroxyethyl)-ethylenediaminetriacetic acid, and hydroxyethyliminodiacetic acid.

3. The cleaning composition as claimed in claim 1, wherein the acid is at least one of phosphonic carboxylic acid and carboxylic acid.

4. The cleaning composition as claimed in claim 3, wherein phosphonic carboxylic acid is selected from at least one of 2-aminoethylphosphonic acid (AEPN), dimethyl methylphosphonate (DMMP), 1-hydroxy ethylidene-1,1-diphosphonic acid (HEDP), amino tris(methylene phosphonic acid) (ATMP), ethylenediamine tetra(methylene phosphonic acid) (EDTMP), tetramethylenediamine tetra(methylene phosphonic acid) (TDTMP), hexamethylenediamine tetra(methylene phosphonic acid) (HDTMP), diethylenetriamine penta(methylene phosphonic acid) (DTPMP), 2-phosphonobutane-1,2,4-tricarboxlic acid (PBTC), N-(phosphonomethyl)iminodiacetic acid) (PMIDA), 2-carboxyethyl phosphonic acid (CEPA) and 2-hydroxyphosphonocarboxylic acid (HPAA).

5. The cleaning composition as claimed in claim 3, wherein carboxylic acid is selected from at least one of formic acid, acetic acid, propionic acid, oxalic acid, acrylic acid, benzoic acid, maleic acid, malic acid, glutaric acid, malonic acid, adipic acid, citric acid, and aconitic acid.

6. The cleaning composition as claimed in claim 1, further comprising a surfactant.

7. The cleaning composition as claimed in claim 6, wherein the surfactant is a nonionic surfactant, an anionic surfactant, or a combination thereof.

8. The cleaning composition as claimed in claim 7, wherein the nonionic surfactant is selected from at least one of alkyl poly(ethylene oxide), alkylphenol poly(ethylene oxide), and alkyl polyglucoside.

9. The cleaning composition as claimed in claim 7, wherein the anionic surfactant is selected from at least one of alkyl sulfate salt and alkyl benzene sulfonate.

10. The cleaning composition as claimed in claim 9, wherein alkyl sulfate salt is selected from at least one of sodium dodecyl sulfate, ammonium lauryl sulfate, and sodium laureth sulfate.

11. The cleaning composition as claimed in claim 9, wherein alkyl benzene sulfonate comprises dodecylbenzene sulfonic acid.

12. The cleaning composition as claimed in claim 1, further comprising an ion enhancer having a content of 0.01 wt % to 0.5 wt %.

13. The cleaning composition as claimed in claim 12, wherein the ion enhancer is selected from at least one of an amine salt, a potassium salt, a sodium salt, and a lithium salt of formic acid, acetic acid, propionic acid, oxalic acid, acrylic acid, benzoic acid, maleic acid, malic acid, glutaric acid, malonic acid, adipic acid, citric acid, aconitic acid, salicylic acid, tartaric acid, glycolic acid, and sulfonic acid.

14. The cleaning composition as claimed in any one of claims 1, wherein the cleaning composition is condensed into a highly concentrated cleaning composition.

15. The cleaning composition as claimed in claim 14, wherein the highly concentrated cleaning composition has a concentration multiple of 20 times to 60 times.

16. The cleaning composition as claimed in claim 1, wherein a pH value of the cleaning composition ranges from 8 to 12.
